(19) United States
(12) Patent Application Publication
(10) Pub. No.: US 2026/0329653 A1
(43) Pub. Date: Oct. 22, 2026

(54) NON-TRANSITORY RECORDING MEDIUM AND INFORMATION PROCESSING APPARATUS

(71) Applicant: PFU Limited, ISHIKAWA (JP)

(72) Inventors: Masanori HONDA, ISHIKAWA (JP); Akira IWAYAMA, ISHIKAWA (JP)

(21) Appl. No.: 19/638,836

(22) Filed: Apr. 3, 2026

(30) Foreign Application Priority Data
Apr. 18, 2025 (JP) 2025-068555

(51) Int. Cl. G06F 9/50

(52) U.S. Cl. CPC G06F 9/5038; G06F 2209/5021; G06F 2209/503

(57) ABSTRACT

A non-transitory computer-readable recording medium storing a plurality of instructions which, when executed by one or more processors of an information processing apparatus, cause the one or more processors to perform a method including obtaining a task, generating an execution plan for the task, determining whether the information processing apparatus holds a priority right to request another information processing apparatus to execute the task, and when the information processing apparatus is determined to hold the priority right, transmitting a request to execute the task to said another information processing apparatus, based on the execution plan.

### CROSS-REFERENCE TO RELATED APPLICATIONS

This patent application is based on and claims priority pursuant to 35 U.S.C. §119(a) to Japanese Patent Application No. 2025-068555, filed on Apr. 18, 2025, in the Japan Patent Office, the entire disclosure of which is hereby incorporated by reference herein.

### BACKGROUND

The present disclosure relates to a non-transitory recording medium and an information processing apparatus.

Information processing systems that process tasks have been proposed. For example, an AI processing node performs distributed processing of AI information.

According to an aspect of the present disclosure, computing resources can be effectively utilized.

### SUMMARY

The non-transitory computer-readable recording medium according to one aspect of the present disclosure stores a plurality of instructions which, when executed by one or more processors of an information processing apparatus, cause the one or more processors to perform a method including obtaining a task, generating an execution plan for the task, determining whether the information processing apparatus holds a priority right to request another information processing apparatus to execute the task, and when the information processing apparatus is determined to hold the priority right, transmitting a request to execute the task to said another information processing apparatus, based on the execution plan.

The non-transitory computer-readable recording medium according to another aspect of the present disclosure stores a plurality of instructions which, when executed by one or more processors of an information processing apparatus, cause the one or more processors to perform a method including determining whether the information processing apparatus holds a priority right to request another information processing apparatus to execute a task, when the information processing apparatus is determined not to hold the priority right, receiving, from said another information processing apparatus, a request to execute the task, and executing the task.

The information processing apparatus according to still another aspect of the present disclosure includes circuitry to generate an execution plan for the task, determine whether the information processing apparatus holds a priority right to request another information processing apparatus to execute the task, and when the information processing apparatus is determined to hold the priority right, transmit a request to execute the task to said another information processing apparatus, based on the execution plan.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of a grid computing system;

FIG. 2 is a diagram illustrating an overview of grid computing;

FIG. 3 is a block diagram illustrating a hardware configuration of a computer;

FIG. 4 is a block diagram illustrating a functional configuration of a grid computing system;

FIG. 5 is a flowchart of a process performed by a grid computing system;

FIG. 6 is a diagram illustrating an example of connection-destination management;

FIG. 7 is a diagram illustrating an example of task analysis;

FIG. 8 is a diagram illustrating an example of a resource check;

FIG. 9 is a diagram illustrating an example of a task-splitting feasibility check;

FIG. 10 is a diagram illustrating an example of route creation;

FIG. 11 is a diagram illustrating an example of task execution;

FIGS. 12A and 12B are diagrams each illustrating an example of task processing time;

FIG. 13 is a flowchart of connection-destination management;

FIG. 14 is a flowchart of task analysis;

FIG. 15 is a flowchart of priority-right control;

FIG. 16 is a flowchart of task execution performed by a requesting edge computer (EC);

FIG. 17 is a flowchart of task execution performed by a requested EC;

FIG. 18 is a diagram illustrating an example of grid computing for confidential data;

FIG. 19 is a diagram illustrating an example of attribute information related to data concealment; and

FIG. 20 is a flowchart of a process performed in grid computing for confidential data.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In this specification and drawings, components having substantially identical functional configurations are denoted by like reference signs, and redundant descriptions thereof are omitted.

### Overall Configuration

An example of an information processing system according to an embodiment of the present disclosure implements grid computing. In the following description, the information processing system is referred to as a “grid computing system.” Grid computing is a technique for constructing a high-performance computing environment by distributing processing among multiple computers communicating with each other via a communication network.

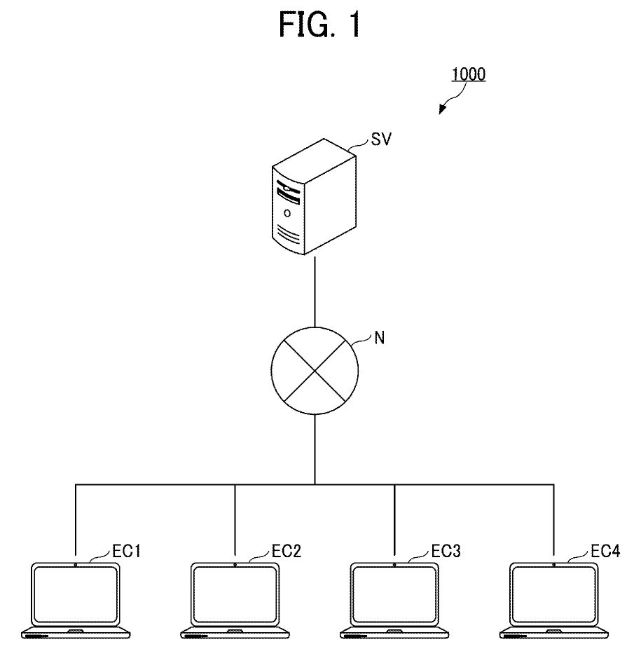

FIG. 1 is a diagram illustrating an overall configuration of a grid computing system. As illustrated in FIG. 1, a grid computing system 1000 includes a server computer SV and edge computers EC (EC1 to EC4). Although FIG. 1 illustrates an example in which the grid computing system 1000 includes four edge computers EC, the grid computing system 1000 may include two or more edge computers EC.

In the following description, when multiple edge computers EC are present, reference signs with suffixes, such as “edge computer EC1” and “edge computer EC2,” are used to distinguish them. Unless otherwise specified, the “edge computer EC” collectively refers to the edge computers EC.

The server computer SV and the edge computer EC are connected to each other via a communication network N for data communication. The communication network N may be, for example, a local area network (LAN), a virtual private network (VPN), or the Internet.

The server computer SV is an example of an information processing apparatus that manages a definition list used in grid computing. The server computer SV may be a computer such as a personal computer, a workstation, or a server. The server computer SV distributes the definition list to the edge computer EC in response to a request from the edge computer EC.

The edge computer EC is an example of an information processing apparatus that participates in grid computing. For example, the edge computer EC may be a computer such as a personal computer, a tablet terminal, or a smartphone. The edge computer EC executes various processes related to grid computing based on the definition list distributed from the server computer SV.

The overall arrangement of the grid computing system 1000 illustrated in FIG. 1 is merely an example, and various system configurations may be adopted depending on the application or purpose. For example, the grid computing system 1000 may include two or more server computers SV. For example, the grid computing system 1000 may include three or fewer edge computers EC or five or more edge computers EC. For example, the server computer SV may be implemented by multiple computers or may be implemented as a cloud computing service. The classification of apparatuses such as the server computer SV and the edge computer EC illustrated in FIG. 1 is merely an example.

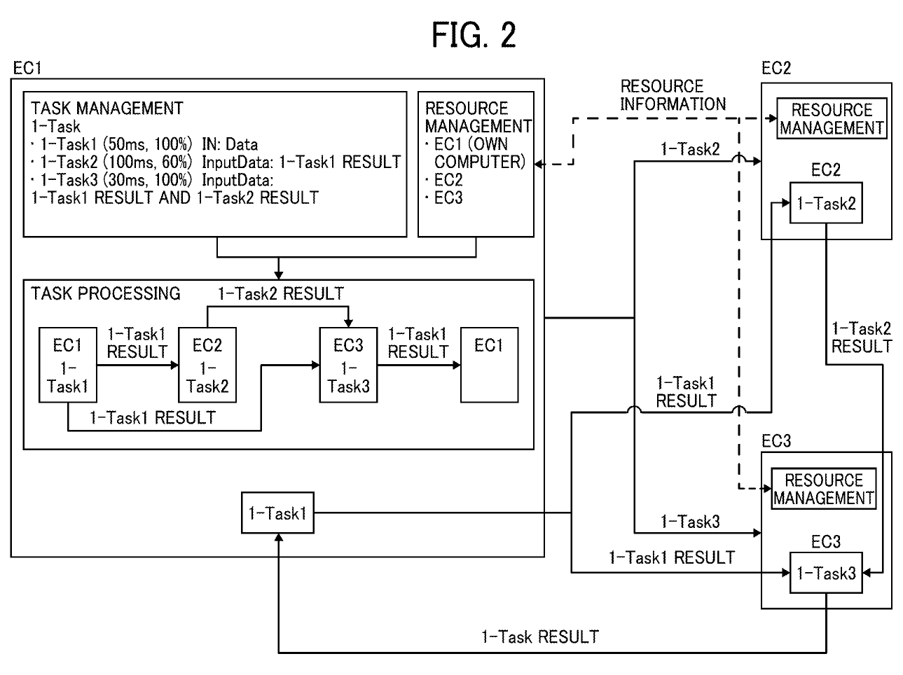

FIG. 2 is a diagram illustrating an overview of grid computing. FIG. 2 illustrates an example of grid computing in which three edge computers EC1 to EC3 participate.

As illustrated in FIG. 2, the edge computer EC1 includes a task management function, a resource management function, and a task processing function. Each of the edge computers EC2 and EC3 also includes the same functions as the edge computer EC1.

The task management function is a function that manages tasks to be processed by grid computing. The task management function splits a task into multiple subtasks and creates an execution plan for the task by analyzing the execution order of subtasks.

The resource management function is a function that manages the computing resources of the edge computers EC. The resource management function shares resource information indicating the computing resources available for executing a task among the edge computers EC.

The task processing function is a function that processes a task in cooperation with the task management function and the resource management function. The task processing function assigns edge computers EC for the respective subtasks indicated in the execution plan based on the resource information, and transmits a request to execute the subtask to the corresponding edge computer EC. In the following description, such a request may be referred to as a “task execution request” or simply an “execution request.” An edge computer EC that receives the task execution request executes the subtask indicated in the execution request and transmits the processing results to the edge computer EC that executes a subsequent subtask.

In FIG. 2, the edge computer EC1 performs distributed processing on a task “1-Task.” The edge computer EC1 splits the task “1-Task” into three subtasks “1-Task1,” “1-Task2,” and “1-Task3.” The edge computer EC1 assigns the edge computer EC1 to the subtask “1-Task1,” the edge computer EC2 to the subtask “1-Task2,” and the edge computer EC3 to the subtask “1-Task3.” The edge computer EC1 transmits a request to execute the subtask “1-Task2” to the edge computer EC2, and transmits a request to execute the subtask “1-Task3” to the edge computer EC3. The edge computer EC2 executes the subtask “1-Task2,” and the edge computer EC3 executes the subtask “1-Task3.” Finally, the edge computer EC1 receives the processing result of the task “1-Task” from the edge computer EC3.

In the following description, the edge computer EC that requests the execution of a task may also be referred to as the “requesting EC.” Further, the edge computer EC that is requested to execute a task may also be referred to as a “requested EC.” In the above description, “EC” has been used as a reference sign. Hereinafter, “EC” is also used as an abbreviation for “edge computer,” and is employed as part of alternative names such as “requesting EC” and “requested EC,” which serve both as reference signs and abbreviations. In FIG. 2, the edge computer EC1 is the requesting EC, and the edge computers EC2 and EC3 are the requested ECs.

A task that the requesting EC requests the requested EC to execute is an example of a first task. A task that the requested EC is requested to execute by the requesting EC is an example of a second task. In FIG. 2, the task “1-Task” is a first task from the perspective of the requesting EC (the edge computer EC1), and is a second task from the perspective of the requested ECs (the edge computers EC2 and EC3).

### Hardware Configuration

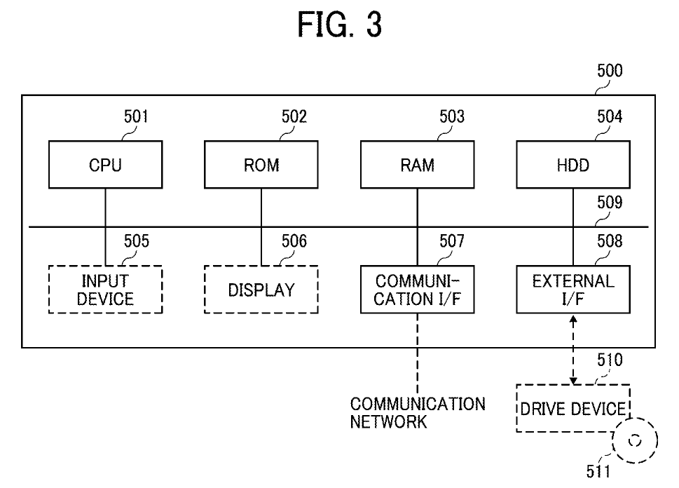

A hardware configuration of the grid computing system 1000 is described with reference to FIG. 3. The server computer SV and the edge computer EC may each be implemented by, for example, a computer. FIG. 3 is a block diagram illustrating a hardware configuration of a computer.

As illustrated in FIG. 3, a computer 500 includes a central processing unit (CPU) 501, a read-only memory (ROM) 502, a random-access memory (RAM) 503, a hard disk drive (HDD) 504, an input device 505, a display 506, a communication interface (I/F) 507, and an external I/F 508. The CPU 501, the ROM 502, and the RAM 503 form a so-called computer. The hardware components of the computer 500 are connected to each other via a bus line 509. The input device 505 and the display 506 may be connected via the external I/F 508 rather than directly to the bus line 509, and this may also be used as a form of use.

The CPU 501 reads programs or data from a memory such as the ROM 502 or the HDD 504 into the RAM 503 and executes processing for controlling the computer 500 or implementing a function of the computer 500. The computer 500 may include a graphics processing unit (GPU) or a neural network processing unit (NPU) in addition to the CPU 501 or instead of the CPU 501.

The ROM 502 is an example of a nonvolatile semiconductor memory (storage device) that retains programs or data even after the power is turned off. The ROM 502 functions as a main memory that stores various programs and data used by the CPU 501 to execute various programs installed on the HDD 504. Specifically, the ROM 502 stores boot programs such as a basic input output system (BIOS) and an external executable firmware interface (EFI) executed at the time of booting the computer 500, and data such as operating system (OS) settings and network settings.

The RAM 503 is an example of a volatile semiconductor memory (storage device) from which programs or data are erased when the power is turned off. The RAM 503 is, for example, a dynamic random-access memory (DRAM) or a static random-access memory (SRAM). The RAM 503 provides a work area for loading various programs installed on the HDD 504 when the programs are executed by the CPU 501.

The HDD 504 is an example of a nonvolatile memory that stores programs or data. The programs or data stored in the HDD 504 include an OS that is basic software for controlling the computer 500 and applications that provide various functions on the OS. The computer 500 may use a memory (for example, a solid-state drive (SSD)) using a flash memory as a storage medium instead of the HDD 504.

The input device 505 is used by a user to input various signals. Examples of the input device 505 include a touch panel, operation keys or buttons, a keyboard, a mouse, and a microphone for inputting audio data such as voice.

The display 506 includes at least a display such as a liquid crystal display or an organic electro-luminescence (EL) display that displays a screen. The display 506 may include a speaker that outputs audio data such as voice.

The communication I/F 507 is an interface for connecting to the communication network N that allows the computer 500 to perform data communication.

The external I/F 508 is an interface that connects the computer 500 to an external device. Examples of the external device include a drive device 510.

The drive device 510 is a device to which a recording medium 511 is placed. Examples of the recording medium 511 include media that optically, electrically, or magnetically record information, such as a compact disc read-only memory (CD-ROM), a flexible disk, and a magneto-optical disk. Examples of the recording medium 511 may also include a semiconductor memory that electrically records information, such as a ROM or a flash memory. The external I/F 508 allows the computer 500 to read or write data from or to the recording medium 511.

For example, the various programs are installed on the HDD 504 by placing the distributed recording medium 511 into the drive device 510 connected to the external I/F 508 and reading the various programs recorded on the recording medium 511 by the drive device 510. Alternatively, the various programs may be installed onto the HDD 504 by downloading from the communication network N or a network other than the communication network N via the communication I/F 507.

### Functional Configuration

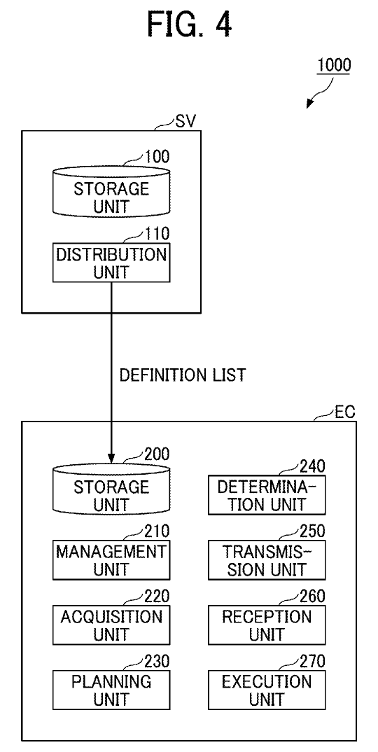

A functional configuration of the grid computing system 1000 is described with reference to FIG. 4. FIG. 4 is a block diagram illustrating a functional configuration of a grid computing system.

As illustrated in FIG. 4, the server computer SV includes a storage unit 100 and a distribution unit 110. The server computer SV functions as the storage unit 100 and the distribution unit 110 by executing one or more pre-installed programs.

For example, the storage unit 100 is implemented by the HDD 504 illustrated in FIG. 3. For example, the distribution unit 110 is implemented by processing executed by the CPU 501 according to a program loaded into the RAM 503 from the HDD 504 illustrated in FIG. 3.

The storage unit 100 stores a definition list. The “definition list” refers to electronic data that defines various information related to the edge computer EC. The definition list is configured, for example, via a web page provided by the server computer SV. The definition list includes, for each edge computer EC, attribute information, communication information, available resource information, and priority-control information.

The attribute information includes a group, a type of data handled, and a security level. The communication information includes connection-destination information, communication cost, and communication time. The available resource information includes information indicating the computing resources available for executing a task (for example, the type, number, performance, memory size, etc., of processors). The priority-right control information includes a priority order within the group, maximum priority-right holding time, and the number of tasks that can be requested. In the following description, the number of tasks that can be requested may be referred to as the number of requestable tasks.

The distribution unit 110 distributes the definition list stored in the storage unit 100 to the edge computer EC. When detecting that the definition list has been updated, the distribution unit 110 may distribute the updated definition list to the edge computer EC. The distribution unit 110 may distribute the definition list to the edge computer EC in response to an operation by the administrator of the grid computing system 1000. The definition list distributed by the distribution unit 110 is stored in the storage unit 200 of the edge computer EC.

As illustrated in FIG. 4, the edge computer EC includes a storage unit 200, a management unit 210, an acquisition unit 220, a planning unit 230, a determination unit 240, a transmission unit 250, a reception unit 260, and an execution unit 270. The edge computer EC functions as the storage unit 200, the management unit 210, the acquisition unit 220, the planning unit 230, the determination unit 240, the transmission unit 250, the reception unit 260, and the execution unit 270 by executing one or more pre-installed programs.

For example, the storage unit 200 is implemented by the HDD 504 illustrated in FIG. 3. For example, the management unit 210, the acquisition unit 220, the planning unit 230, the determination unit 240, the transmission unit 250, the reception unit 260, and the execution unit 270 are implemented by processing that is executed by the CPU 501 according to a program that is loaded from the HDD 504 illustrated in FIG. 3 into the RAM 503 illustrated in FIG. 3.

The storage unit 200 stores a definition list distributed from the server computer SV. The storage unit 200 also stores a queue of tasks. The storage unit 200 may store multiple queues for different purposes. The storage unit 200 also stores connection-destination information indicating the connection destinations of other edge computers EC. Further, the storage unit 200 stores resource information indicating the computing resources of the edge computer EC.

The resource information includes the available resource information of the edge computer EC. The “available resource information” refers to information indicating computing resources available for the edge computer EC to execute a task. For example, the available resource information may include an available memory capacity, a maximum data size acceptable for processing, and an unused rate of a processor such as a CPU, a graphics processing unit (GPU), or a neural processing unit (NPU).

The resource information further includes information about a priority right (priority-right information). The “priority right” refers to an entitlement that allows an edge computer EC to request another edge computer EC to execute a task. The priority right is controlled such that, among multiple edge computers EC participating in grid computing, only one edge computer EC can hold the priority right at a time.

The priority-right information includes information indicating the edge computer EC currently holding the priority right, an elapsed priority-right holding time, and the number of task requests. The “elapsed priority-right holding time” refers to the period elapsed since the priority right began to be held. The “number of task requests” refers to the number of times the edge computer EC requests another edge computer EC to execute a task while the priority right is held. The information indicating the edge computer EC holding the priority right is set based on the priority-right control information in the definition list. The elapsed priority-right holding time is information related to the maximum priority-right holding time defined in the definition list. The number of task requests is information related to the number of requestable tasks defined in the definition list.

Switching of the edge computer EC that holds the priority right is controlled based on at least one of a priority order, an elapsed priority holding time, the number of task requests, and an idle time. A priority order is pre-assigned to each edge computer EC and is recorded in the definition list. The “idle time” refers to a length of time during which the processor or the memory is 100% idle.

When the priority right is controlled based on the elapsed priority-right holding time, the control is performed such that, when the elapsed priority-right holding time exceeds a threshold, the edge computer EC holding the priority right is switched to another edge computer EC. The threshold can be the maximum priority-right holding time defined in the definition list. The maximum priority-right holding time may vary for each edge computer EC.

When the priority right is controlled based on the number of task requests, the control is performed such that, when the number of task requests exceeds a threshold, the edge computer EC is switched to another edge computer EC. The threshold can be the number of requestable tasks defined in the definition list. The number of requestable tasks may vary for each edge computer EC.

The acquisition unit 220 acquires a task. The acquisition unit 220 may receive a task input from an external source. The acquisition unit 220 may read a task stored in a queue.

The planning unit 230 generates an execution plan for a task. The planning unit 230 splits a task into multiple subtasks and generates an execution plan that specifies the execution order of the subtasks. For example, the planning unit 230 may create an execution plan to concurrently execute multiple subtasks that can be processed in parallel on multiple edge computers EC. For example, the planning unit 230 may also generate an execution plan so that the execution times of subtasks that are to be processed in series do not overlap.

The planning unit 230 assigns, for each subtask included in the execution plan for the task, another edge computer EC (a requested EC) to which execution of the subtask is to be requested. The planning unit 230 may assign a requested EC to each subtask based on available resource information of other edge computers EC.

The determination unit 240 determines whether the local edge computer EC holds the priority right. In this specification, the term “local edge computer EC” is used to indicate the edge computer EC that performs the relevant processing.

The determination unit 240 may determine whether the local edge computer EC (own edge computer EC) holds the priority right when the edge computer EC does not have available resources to execute a task.

The transmission unit 250 transmits a task execution request to another edge computer EC (a requested EC) based on the execution plan for the task. The transmission unit 250 may transmit a task execution request to the requested EC when the determination unit 240 determines that the local edge computer EC holds the priority right. The transmission unit 250 may transmit a task execution request to the requested EC when the local edge computer EC (a requesting EC) does not have available resources to execute the task.

The reception unit 260 receives a task execution request from another edge computer EC (a requesting EC). The reception unit 260 may receive a task execution request from the requesting EC when the determination unit 240 determines that the local edge computer EC does not hold the priority right. The reception unit 260 may receive a task execution request from the requesting EC when the local edge computer EC has available resources for executing a task.

The execution unit 270 executes a task. The execution unit 270 executes a task acquired by the acquisition unit 220 when the local edge computer EC has available resources for executing the task. When the reception unit 260 receives a task execution request, the execution unit 270 executes a task (subtask) indicated in the task execution request.

A program installed on the edge computer EC may be a program that causes the edge computer EC to function as the storage unit 200, the management unit 210, the acquisition unit 220, the planning unit 230, the determination unit 240, the transmission unit 250, the reception unit 260, and the execution unit 270. That is, a program installed on the edge computer EC may cause the edge computer EC to function as both a requesting EC and a requested EC.

A program installed on the edge computer EC may be a program that causes the edge computer EC to function as the storage unit 200, the management unit 210, the acquisition unit 220, the planning unit 230, the determination unit 240, and the transmission unit 250. That is, a program installed on the edge computer EC may also be a program that causes the edge computer EC to function only as a requesting EC.

A program installed on the edge computer EC may be a program that causes the edge computer EC to function as the storage unit 200, the management unit 210, the determination unit 240, the reception unit 260, and the execution unit 270. That is, a program installed on the edge computer EC may also be a program that causes the edge computer EC to function only as a requested EC.

The functional configuration of the grid computing system 1000 illustrated in FIG. 4 is merely an example, and various functional configurations may be adopted depending on the application or purpose. The classifications of the storage and processing units of the server computer SV, such as the storage unit 100 and the distribution unit 110 illustrated in FIG. 4, are examples. Similarly, the classifications of the storage and processing units of the edge computer EC, such as the storage unit 200, the management unit 210, the acquisition unit 220, the planning unit 230, the determination unit 240, the transmission unit 250, the reception unit 260, and the execution unit 270 illustrated in FIG. 4, are examples.

### Overview of Processes

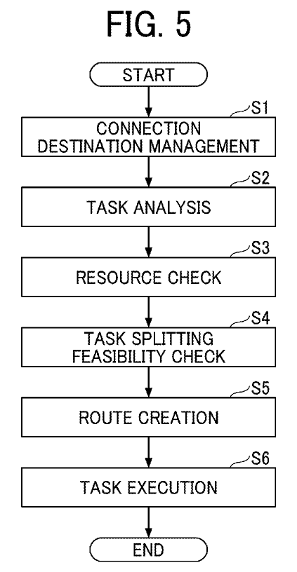

An overview of processes performed by the grid computing system 1000 is described with reference to FIGS. 5-12. FIG. 5 is a flowchart of a process performed by a grid computing system. In the following description, “each edge computer EC” is used for operations that all participating edge computers perform, while “the local edge computer EC” is used for operations performed by the executing edge computer EC. For convenience, an edge computer EC that executes a step may be referred to as “the local edge computer EC.” Where a step is performed by each edge computer EC, details of the step may be described from the perspective of the local edge computer EC as a representative example.

In step S1, the grid computing system 1000 performs connection-destination management. The connection-destination management is performed in advance before processing a task. The connection-destination management is performed by each edge computer EC participating in grid computing.

In the connection-destination management, the local edge computer EC checks connection-destination information including a communication destination address and communication cost (time) of one or more edge computers EC that can serve as connection destinations, based on the definition list. An edge computer EC that can serve as a connection destination is an edge computer EC that can serve as a requesting EC or as a requested EC from the standpoint of the local edge computer EC. The “communication cost” refers to a communication time incurred when requesting execution of a task, or a communication fee involved in such requesting.

In step S2, the grid computing system 1000 performs task analysis. The task analysis is performed in advance before processing a task. The task analysis is performed on a task by the edge computer EC that is to process the task.

In the task analysis, the local edge computer EC analyzes a task and checks computing resources to be used to execute the task. For example, the local edge computer EC splits a task to be processed into subtasks and determines an execution order of the subtasks. Further, the local edge computer EC determines the computing resources to be used to execute each subtask.

In step S3, the grid computing system 1000 performs a resource check. The resource check is performed at predetermined time intervals. The predetermined time interval may be, for example, 3 hours, 12 hours, or 24 hours. The resource check is performed by each edge computer EC participating in grid computing.

In the resource check, the local edge computer EC estimates available resource information based on the analysis results of a task currently being executed and the analysis results of a task to be executed in the future. Further, the local edge computer EC distributes the estimated available resource information to edge computers EC belonging to the same group.

In step S4, the grid computing system 1000 performs a task-splitting feasibility check. The task-splitting feasibility check is performed when a task is processed. The task-splitting feasibility check is performed by the edge computer EC that is to process a task.

In the task-splitting feasibility check, the local edge computer (that is, the requesting EC) with an insufficient computing resource checks the availability of another edge computer as well as the communication cost. The other edge computer EC (that is, the requested EC) to be requested to execute the task is determined based on the attribute information in the definition list. The local edge computer EC that can request to execute a task (that is, the edge computer EC that holds the priority right) is determined based on the priority-control information in the definition list.

In step S5, the grid computing system 1000 performs route creation. The route creation is performed when a task is processed. The route creation is performed by the edge computer EC that processes a task.

In the route creation, the local edge computer (that is, the requesting EC) creates a route for executing a task. The “route” refers to an execution plan in which an edge computer EC is assigned to each subtask. The requesting EC assigns, as a requested EC for each subtask, an edge computer EC that responded as available to execute the subtask in the task-splitting feasibility check.

In step S6, the grid computing system 1000 performs task execution. The task execution is performed when a task is processed. The task execution is performed by the edge computer EC that processes a task.

In the task execution process, the local edge computer (that is, the requesting EC) transmits task execution requests to respective requested ECs according to the route created in the route creation. Each requested EC executes the subtask in response to the task execution request and transmits a processing result to the requesting EC. As a result, the requesting EC obtains a processing result of the task. In the task execution, the requested EC may store information about computing resources used to execute the task and may calculate a reward to be provided from the requesting EC to the requested EC based on the computing resources.

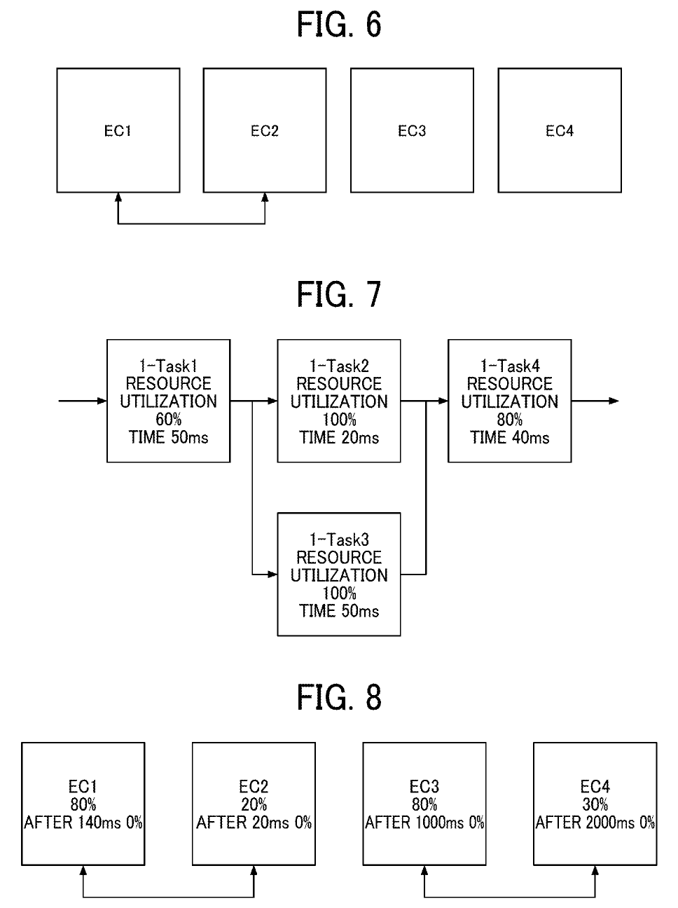

FIG. 6 is a diagram illustrating an example of connection-destination management. In FIG. 6, the edge computer EC1 and the edge computer EC2 have the same attribute information. Because task execution may be requested mutually between the edge computers EC1 and EC2, the edge computers EC1 and EC2 mutually check the connection-destination information.

FIG. 7 is a diagram illustrating an example of task analysis. In FIG. 7, an execution plan in which a task “1-Task” is split into four subtasks “1-Task1,” “1-Task2,” “1-Task3,” and “1-Task4” is illustrated. In this execution plan, after the subtask “1-Task1” is executed, the subtasks “1-Task2” and “1-Task3” are processed in parallel, and finally, the subtask “1-Task4” is executed. Each subtask is also analyzed for resource utilization rate and execution time.

FIG. 8 is a diagram illustrating an example of a resource check. In FIG. 8, the edge computer EC1 and the edge computer EC2 have the same attribute information, and the edge computer EC3 and the edge computer EC4 have the same attribute information. The edge computer EC1 and the edge computer EC2 share available resource information by mutually distributing their own available resource information. Similarly, the edge computer EC3 and the edge computer EC4 share available resource information by mutually distributing their own available resource information.

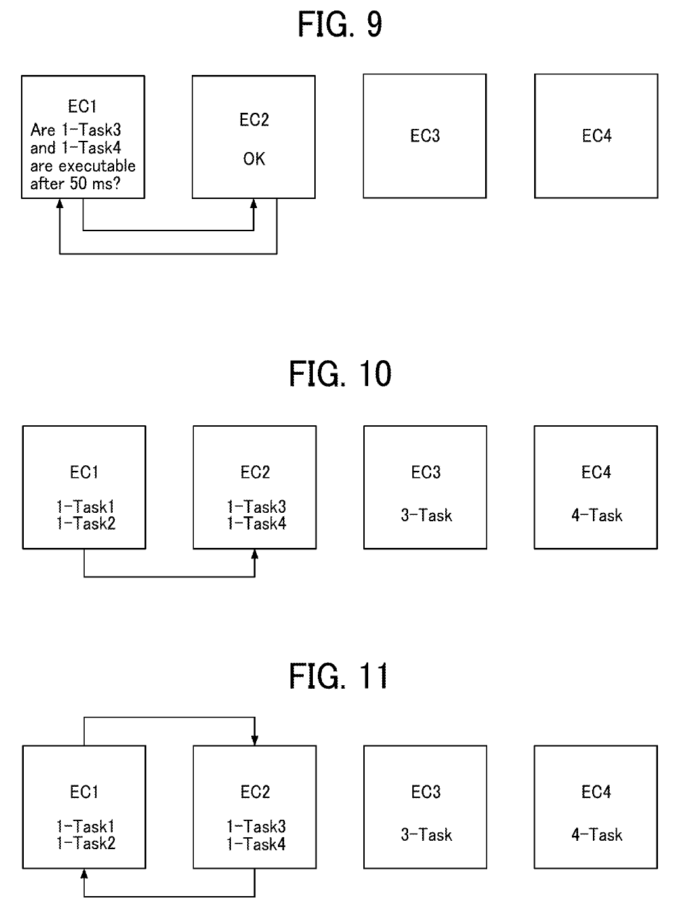

FIG. 9 is a diagram illustrating an example of a task-splitting feasibility check. In FIG. 9, the edge computer EC1 checks whether the edge computer EC2 can execute the subtasks “1-Task3” and “1-Task4.” In this case, the edge computer EC1 holds the priority right and lacks sufficient computing resources to execute the subtasks “1-Task3” and “1-Task4.” The edge computer EC2 has available resources to execute the subtasks “1-Task3” and “1-Task4,” and responds that the subtasks “1-Task3” and “1-Task4 can be executed by the edge computer EC2.

FIG. 10 is a diagram illustrating an example of route creation. In FIG. 10, the edge computer EC1 executes the subtasks “1-Task1” and “1-Task2,” and the edge computer EC2 executes the subtasks “1-Task3” and “1-Task4.”

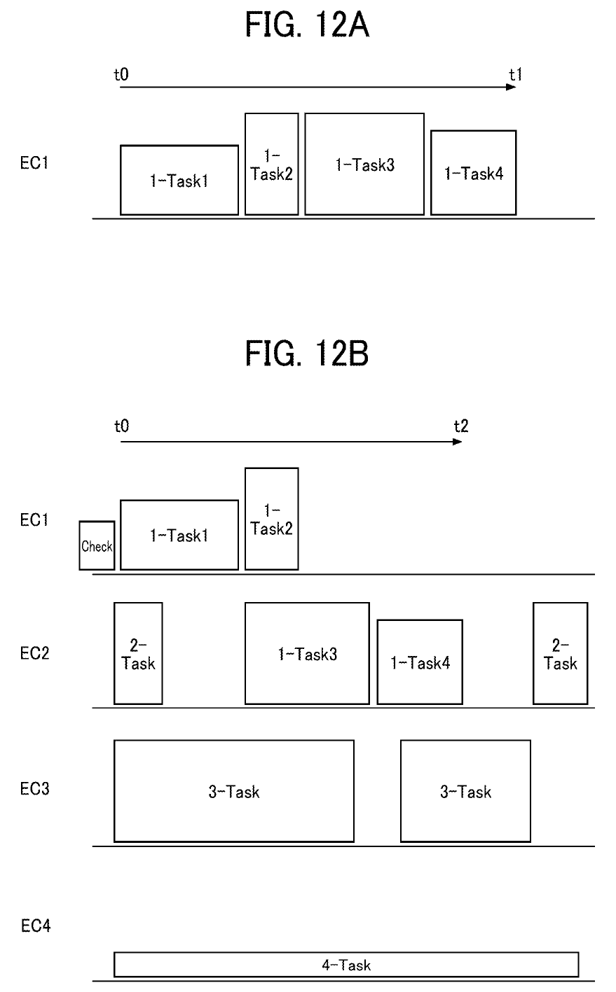

FIG. 11 is a diagram illustrating an example of task execution. In FIG. 11, the edge computer EC1 transmits the execution results of the subtasks “1-Task1” and “1-Task2” to the edge computer EC2, and the edge computer EC2 transmits the execution results of the subtasks “1-Task3” and “1-Task4” to the edge computer EC1. As a result, the task “1-Task” is processed in a distributed manner, and the edge computer EC1 can obtain the processing result of the task “1-Task.”

FIGS. 12A and 12B are diagrams each illustrating an example of task processing time. FIG. 12A illustrates an example of task processing time in the related art. FIG. 12B is a diagram illustrating an example of task processing time according to the present embodiment. In the related art, it is assumed that when the task “1-Task” is executed by a single edge computer EC1, a processing time from time t0 to time t1 elapses. When the task “1-Task” is processed in a distributed manner by the edge computer EC1 and the edge computer EC2, a processing time from time t0 to time t2 elapses. Further, the edge computer EC2 can execute the task “2-Task” during the time the edge computer EC2 is not executing the subtask “1-Task3” and the subtask “1-Task4.” Accordingly, FIGS. 12A and 12B illustrate that, according to the present embodiment, the execution time of the task can be reduced and computing resources can be effectively utilized.

Specific examples of a task executed by the grid computing system 1000 are described below.

A first specific example is a task of creating or summarizing minutes of a meeting involving multiple participants. The task of creating (or summarizing) minutes can be split into the following subtasks: a first subtask, a second subtask, a third subtask, and a fourth subtask.

The first subtask is acquisition of audio, noise reduction, and audio separation. The second subtask is speaker detection and speaker separation. The third subtask is speech recognition. The fourth subtask is the generation (or summarization) of the text that is to be the minutes.

Among the subtasks described above, the second subtask and the third subtask can be processed for each speaker. Accordingly, the second subtask and the third subtask can be requested to be executed by one or more edge computers EC.

A second specific example is a task of detecting abnormal behavior of a person captured on a camera image. The task of detecting abnormal behavior from a camera image can be split into the following subtasks: a first subtask, a second subtask, a third subtask, and a fourth subtask.

The first subtask is acquisition of input video and preprocessing. The second subtask is person detection from the input video. The third subtask is tracking a person’s behavior. The fourth subtask is behavior analysis and anomaly detection.

Among the subtasks described above, the fourth subtask can be processed for each person captured in the video. Accordingly, the fourth subtask can be requested to be executed by one or more edge computers EC.

### Details of Processes

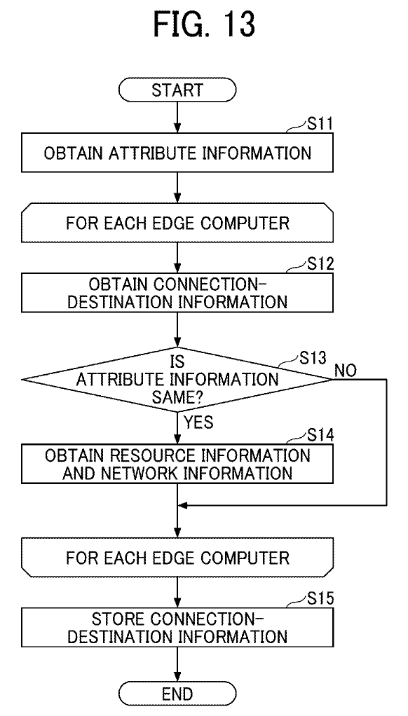

Details of processes performed by the grid computing system 1000 are described with reference to FIGS. 13-17. In the following description, an edge computer EC that executes a step may be referred to as “the local edge computer EC.” For clarity, in the flowchart descriptions, operations involving a counterpart device are described using “another edge computer EC.”

FIG. 13 is a flowchart of connection-destination management. The connection-destination management in FIG. 13 corresponds to step S1 in FIG. 5.

In step S11, the management unit 210 of the local edge computer EC reads the definition list from the storage unit 200. The management unit 210 obtains the attribute information of each of the other edge computers EC from the read definition list.

In step S12, the management unit 210 of the local edge computer EC obtains the connection-destination information of each of the other edge computers EC from the definition list received from the server computer SV and stored in the storage unit 200. Network information may include resource information or delay time. The delay time is an increment in processing time that varies depending on device load during network communication. In response to an inquiry, each of the other edge computers EC transmits the network information to the local edge computer EC. The management unit 210 receives the network information from each of the other edge computers EC.

In step S13, the management unit 210 of the local edge computer EC determines whether the attribute information of the local computer matches attribute information of another edge computer EC. This processing is performed for each of the other edge computers EC. For example, a group of the attribute information is checked, and whether another edge computers EC belongs to the same project as the local edge computer EC. This is because, when a task involves confidential information such as personal information, it is desirable to narrow down the destination to which the task is requested. When the management unit 210 determines that the attribute information of the local computer matches the attribute information of another edge computer EC (YES), the process proceeds to step S14. On the other hand, when the management unit 210 determines that the attribute information of the local computer does not match the attribute information of another edge computer EC (NO), step S14 is skipped.

In step S14, the management unit 210 of the local edge computer EC inquires of another edge computer EC about resource information and network information. This processing is performed for each of the other edge computers EC determined to have the same attribute information as the local edge computer EC in step S13. The information to be inquired about may include delay time. In response to the inquiry, another edge computer EC transmits resource information and network information to the edge computer EC. The management unit 210 stores the resource information and the network information of another edge computer EC, received from another edge computer EC.

Either steps S12 and S13 are performed, or steps S12 to S14 are performed, for each edge computer EC whose attribute information was obtained in step S11. As a result, the edge computer EC obtains connection-destination information for each of the other edge computers EC that have the same attribute information as the local edge computer EC.

In step S15, the management unit 210 of the edge computer EC stores the connection-destination information obtained in step S12 in the storage unit 200. At this time, the management unit 210 stores in the storage unit 200 the connection-destination information of each of the edge computers EC that responded to the inquiry about the network information in step S12. This allows the local edge computer to prevent requesting execution of a task to an edge computer EC whose connection-destination information is described in the definition list but which is not actually operating.

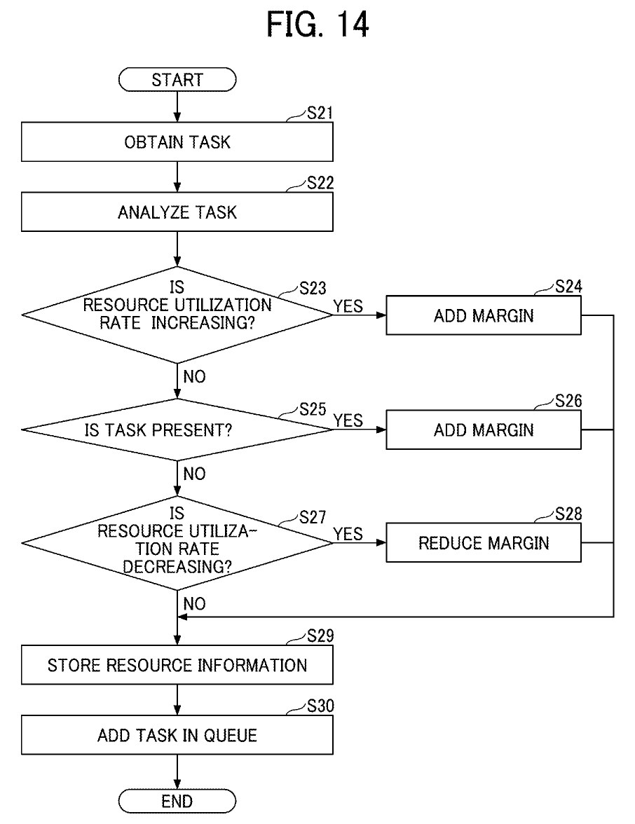

FIG. 14 is a flowchart of task analysis. The task analysis in FIG. 14 corresponds to step S2 in FIG. 5.

In step S21, the acquisition unit 220 of the local edge computer EC acquires a task to be processed by the local edge computer EC. The acquisition unit 220 may receive a task input from an external source. The acquisition unit 220 may read a task from a queue stored in the storage unit 200. The acquisition unit 220 transmits the acquired task to the planning unit 230.

In step S22, the planning unit 230 of the local edge computer EC receives the task from the acquisition unit 220. The planning unit 230 analyzes the task. For example, the planning unit 230 analyzes a computing resource or processing time to execute the task. The planning unit 230 also splits the task into one or more subtasks and analyzes the execution order of the subtasks. Further, the planning unit 230 analyzes, for example, the computing resources, the processing time, the size of data input and output between the subtasks for executing the subtasks. The planning unit 230 generates an execution plan for the task based on the analysis results and stores the execution plan in the storage unit 200.

In step S23, the management unit 210 of the local edge computer EC determines whether the resource utilization rate of the local edge computer EC tends to increase. When the management unit 210 determines that the resource utilization rate tends to increase (YES), the process proceeds to step S24. When the management unit 210 determines that the resource utilization rate does not tend to increase (NO), the process proceeds to step S25.

In step S24, the management unit 210 of the local edge computer EC adds a predetermined margin (for example, 20%) to the resource utilization rate of the local edge computer EC (in other words, reduces the available resources by the predetermined margin). Further, when the resource utilization rate continues to increase for a certain period of time, the management unit 210 may add a larger margin (for example, 40%) to the resource utilization rate. The resource information may be set for each processor (CPU, GPU, or NPU) in each of the edge computers EC. The resource information may also be set by summing up the processors (CPUs, GPUs, or NPUs) of the entire grid computing system 1000.

In step S25, the management unit 210 of the local edge computer EC determines whether a task to be processed by the local edge computer EC is present in a queue stored in the storage unit 200. When the management unit 210 determines that a task is present in a queue (YES), the process proceeds to step S26. On the other hand, when the management unit 210 determines that no task is present in a queue (NO), the process proceeds to step S27.

In step S26, the management unit 210 of the local edge computer EC adds a predetermined margin (for example, 20%) to the resource utilization rate of the local edge computer EC (in other words, reduces the available resources by the predetermined margin). Further, the management unit 210 may add a larger margin (for example, 40%) to the resource utilization rate when a task is present in a queue for a certain period of time.

In step S27, the management unit 210 of the local edge computer EC determines whether the resource utilization rate of the local edge computer EC tends to decrease. When the management unit 210 determines that the resource utilization rate tends to decrease (YES), the process proceeds to step S28. When the management unit 210 determines that the resource utilization rate does not tend to decrease (NO), the process proceeds to step S29.

In step S28, the management unit 210 of the local edge computer EC reduces the resource utilization rate of the local edge computer EC by a predetermined margin (for example, 20%) (in other words, increases the available resources by the predetermined margin). Further, when the resource utilization rate continues to decrease for a certain period of time, the management unit 210 may reduce the resource utilization rate by a larger margin (for example, 40%).

In step S29, the management unit 210 of the local edge computer EC stores the resource information in the storage unit 200. The resource information is shared in the resource check (step S3 in FIG. 5) among the edge computers EC participating in grid computing.

In step S30, the acquisition unit 220 of the local edge computer EC adds the task acquired in step S21 to the queue stored in the storage unit 200.

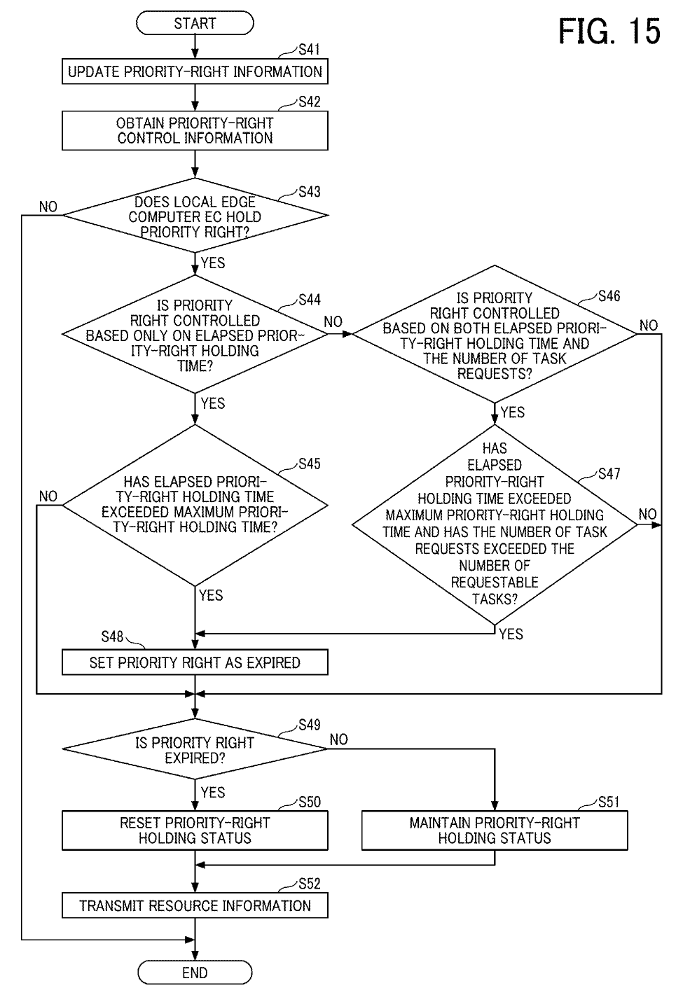

FIG. 15 is a flowchart of priority-right control. The priority-right control in FIG. 15 is performed before step S4 in FIG. 5. FIG. 15 illustrates an example of controlling the priority right based on at least one of an elapsed priority-right holding time and the number of task requests.

In step S41, the management unit 210 of the local edge computer EC updates priority-right information. When controlling the priority right based on an elapsed priority-right holding time, the management unit 210 recalculates the elapsed priority-right holding time based on the current time. When controlling the priority right based on the number of task requests, the management unit 210 obtains the number of task requests from the edge computer EC that currently holds the priority right.

In step S42, the management unit 210 of the local edge computer EC reads the definition list from the storage unit 200. The management unit 210 obtains the priority-right control information from the definition list. In the present embodiment, the management unit 210 obtains the maximum priority-right holding time and the number of requestable tasks of the local edge computer EC.

In step S43, the management unit 210 of the local edge computer EC reads the resource information from the storage unit 200. The management unit 210 obtains information indicating the edge computer EC that currently holds the priority right from the resource information. The management unit 210 determines whether the local edge computer EC currently holds the priority right. When the management unit 210 determines that the local edge computer EC currently holds the priority right (YES), the process proceeds to step S44. On the other hand, when the management unit 210 determines that the local edge computer EC does not currently hold the priority right (NO), the process ends.

In step S44, the management unit 210 of the local edge computer EC determines whether to control the priority right based only on an elapsed priority-right holding time. When the management unit 210 determines that the priority right is controlled based only on an elapsed priority-right holding time (YES), the process proceeds to step S45. On the other hand, when the management unit 210 determines that the priority right is not controlled based only on an elapsed priority-right holding time (NO), the process proceeds to step S46.

In step S45, the management unit 210 of the edge computer EC determines whether the elapsed priority-right holding time has exceeded the maximum priority-right holding time. When the management unit 210 determines that the elapsed priority-right holding time has exceeded the maximum priority-right holding time (YES), the process proceeds to step S48. On the other hand, when the management unit 210 determines that the elapsed priority-right holding time does not exceed the maximum priority-right holding time (NO), the process skips step S48 and proceeds to step S49.

In step S46, the management unit 210 of the local edge computer EC determines whether to control the priority right based on both an elapsed priority-right holding time and the number of task requests. Whether to make the determination based on both an elapsed priority-right holding time and the number of task requests or based on either an elapsed priority-right holding time or the number of task requests can be specified in advance among the edge computers EC participating in grid computing. Further, for example, information indicating whether the determination is based on both an elapsed priority-right holding time and the number of task requests or based on either an elapsed priority-right holding time or the number of task requests can be defined in the definition list distributed from the server computer SV. When the management unit 210 determines to control the priority right based on both an elapsed priority-right holding time and the number of task requests (YES), the process proceeds to step S47. On the other hand, when the management unit 210 determines that the priority right is not controlled by using both an elapsed priority-right holding time and the number of task requests (NO), the process proceeds to step S49.

In step S47, the management unit 210 of the edge computer EC determines whether the elapsed priority-right holding time has exceeded the maximum priority-right holding time and whether the number of task requests has exceeded the number of requestable tasks. When the management unit 210 determines that the elapsed priority-right holding time has exceeded the maximum priority holding time and the number of task requests has exceeded the number of requestable tasks (YES), the process proceeds to step S48. On the other hand, when the management unit 210 determines that the elapsed priority-right holding time has not exceeded the maximum priority holding time and the number of task requests has not exceeded the number of requestable tasks (NO), the process skips step S48 and proceeds to step S49.

In step S48, the management unit 210 of the local edge computer EC determines that the currently held priority right has expired. The management unit 210 sets information indicating that the priority has expired in the priority-right information.

In step S49, the management unit 210 of the local edge computer EC determines whether the information indicating that the priority right has expired is set in the priority-right information. When the management unit 210 determines that the information indicating that the priority right has expired is set in the priority-right information (YES), the process proceeds to step S50. In step S50, the management unit 210 of the local edge computer EC determines to reset the priority-right holding status. On the other hand, when the management unit 210 determines that the information indicating that the priority right has expired is not set in the priority-right information (NO), the process proceeds to step S51. In step S51, the management unit 210 of the local edge computer EC determines to maintain the priority-right holding status.

In step S52, the management unit 210 of the local edge computer EC sets the priority-holding status in the resource information. When resetting the priority-right holding status, the management unit 210 deletes the information indicating the edge computer EC that currently holds the priority right from the resource information. Alternatively, the management unit 210 may update the resource information by setting the information indicating the edge computer EC that currently holds the priority right to a blank. When the priority right holding status is to be maintained, the management unit 210 maintains the information indicating the edge computer EC that currently holds the priority right in the resource information (in other words, the management unit 210 does not update the resource information).

The management unit 210 of the local edge computer EC stores the updated resource information in the storage unit 200. The updated resource information is shared in the resource check (step S3 in FIG. 5) among the edge computers EC participating in grid computing. As a result, the edge computer EC that currently holds a priority right is recognizable by all of the edge computers EC.

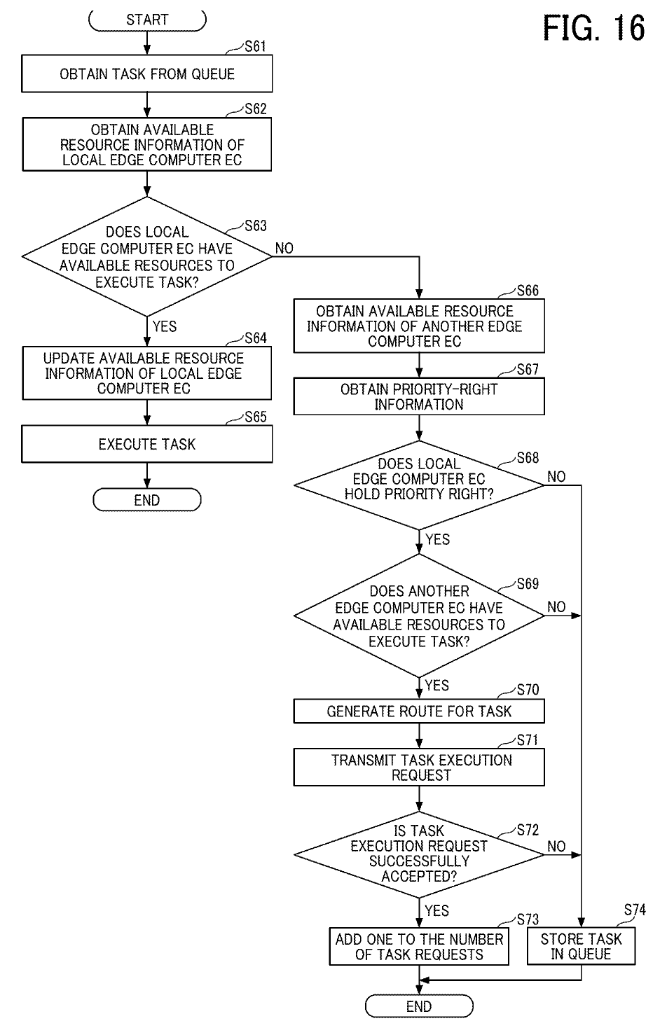

FIG. 16 is a flowchart of task execution performed by a requesting EC. The task execution in FIG. 16 corresponds to steps S4 to S6 in FIG. 5 performed by the requesting EC.

In step S61, the acquisition unit 220 of the local edge computer EC reads a task from a queue stored in the storage unit 200. The acquisition unit 220 transmits the read task to the planning unit 230. The planning unit 230 reads an execution plan for the task from the storage unit 200. The planning unit 230 transmits the execution plan for the task to the determination unit 240.

In step S62, the determination unit 240 of the local edge computer EC receives the execution plan for the task from the planning unit 230. The determination unit 240 reads the resource information from the storage unit 200. The determination unit 240 obtains the available resource information of the local edge computer EC from the read resource information.

In step S63, the determination unit 240 of the local edge computer EC determines whether the local edge computer EC has available resources for executing the task based on the execution plan for the task and the available resource information of the local edge computer EC. When the determination unit 240 determines that there are available resources for executing the task (YES), the process proceeds to step S64. On the other hand, when the determination unit 240 determines that there are no available resources for executing the task (NO), the process proceeds to step S66.

In step S64, the management unit 210 of the local edge computer EC updates the available resource information of the local edge computer EC in the resource information. Specifically, the management unit 210 reduces available resources by the computing resources used for executing the task. The management unit 210 stores the updated resource information in the storage unit 200.

In step S65, the execution unit 270 of the local edge computer EC executes the task obtained in step S61. When the execution of the task is completed, the execution unit 270 outputs an execution result.

In step S66, the management unit 210 of the local edge computer EC requests another edge computer EC to provide resource information. Another edge computer EC updates the available resource information based on the current available resources. The updated available resource information is distributed to each of the other edge computers EC and stored in the storage unit 200 of each of the other edge computers EC.

In step S67, the determination unit 240 of the local edge computer EC reads the latest resource information from the storage unit 200. The determination unit 240 obtains information indicating the edge computer EC that currently holds the priority right from the read resource information. Further, the determination unit 240 obtains the available resource information of each of the other edge computers EC from the read resource information.

In step S68, the determination unit 240 of the local edge computer EC determines whether the local edge computer EC holds the priority right. When the determination unit 240 determines that the local edge computer EC holds the priority right (YES), the process proceeds to step S69. On the other hand, when the determination unit 240 determines that the local edge computer EC does not hold the priority right (NO), the process proceeds to step S74.

In step S69, the determination unit 240 of the local edge computer EC determines whether another edge computer EC has available resources to execute the task, based on the execution plan for the task and the available resources of another edge computer EC. When the determination unit 240 determines that there are available resources for executing the task (YES), the process proceeds to step S70. On the other hand, when the determination unit 240 determines that there are no available resources for executing the task (NO), the process proceeds to step S74.

In step S70, the planning unit 230 of the local edge computer EC generates a route for executing the task based on the task execution plan. Specifically, the planning unit 230 assigns, as the requested EC for each subtask included in the execution plan for the task, another edge computer EC determined in step S69 to have available resources for executing the task. The planning unit 230 transmits the generated route to the transmission unit 250.

In step S71, the transmission unit 250 of the local edge computer EC receives the route from the planning unit 230. The transmission unit 250 transmits a task execution request to the edge computer EC assigned as the requested EC for the subtask, based on the route.

In step S72, the transmission unit 250 of the local edge computer EC determines whether the task execution request is successfully accepted. When the transmission unit 250 determines that the task execution request is successfully accepted (YES), the process proceeds to step S73. On the other hand, when the transmission unit 250 determines that the task execution request is not successfully accepted (NO), the process proceeds to step S74.

In step S73, the management unit 210 of the local edge computer EC adds one to the number of task requests in the priority-right information. The management unit 210 stores the resource information in which the priority information is updated in the storage unit 200.

In step S74, the acquisition unit 220 of the local edge computer EC stores the task obtained in step S61 in the queue stored in the storage unit 200. The task stored in the queue is obtained in step S61 again when the task execution is performed again.

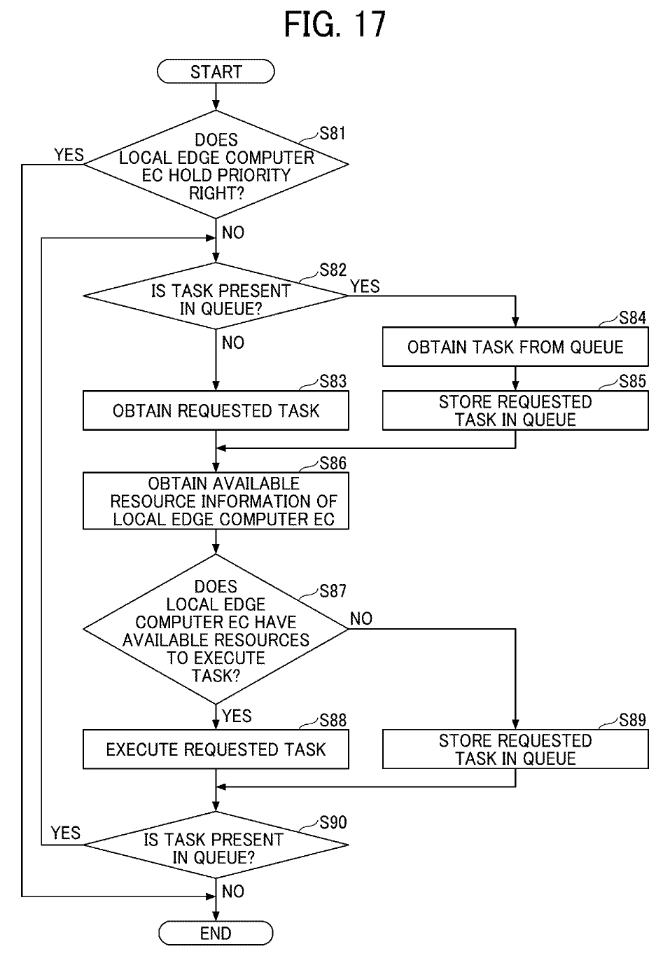

FIG. 17 is a flowchart of task execution performed by a requested EC. The task execution in FIG. 17 corresponds to step S6 in FIG. 5 performed by the requested EC.

In step S81, the determination unit 240 of the local edge computer EC reads the resource information from the storage unit 200. The determination unit 240 obtains information indicating the edge computer EC that currently holds the priority right from the read resource information. The determination unit 240 determines whether the local edge computer EC currently holds the priority right. When the determination unit 240 determines that the local edge computer EC does not currently hold the priority right (NO), the process proceeds to step S82. On the other hand, when the determination unit 240 determines that the local edge computer EC currently holds the priority right (YES), the process ends.

In step S82, the acquisition unit 220 of the local edge computer EC determines whether a task is stored in a queue stored in the storage unit 200. When the acquisition unit 220 determines that no task is stored in the queue (NO), the process proceeds to step S83. On the other hand, when the acquisition unit 220 determines that a task is stored in the queue (YES), the process proceeds to step S84.

In step S83, the reception unit 260 of the local edge computer EC receives a task execution request from another edge computer EC (requesting EC). The reception unit 260 obtains the task (subtask) included in the task execution request.

In step S84, the acquisition unit 220 of the local edge computer EC reads the task from the queue stored in the storage unit 200.

In step S85, the reception unit 260 of the local edge computer EC receives a task execution request from another edge computer EC (requesting EC). The reception unit 260 obtains the task (subtask) included in the task execution request. The reception unit 260 stores the obtained task in the queue stored in the storage unit 200. The task stored in the queue is obtained by the acquisition unit 220 when step S84 is executed again.

In step S86, the determination unit 240 of the local edge computer EC reads the resource information from the storage unit 200. The determination unit 240 obtains the available resource information of the local edge computer EC from the read resource information.

In step S87, the determination unit 240 of the local edge computer EC determines whether the local edge computer EC has available resources for executing the task based on the available resource information of the local edge computer EC. When the determination unit 240 determines that there are available resources for executing the task (YES), the process proceeds to step S88. On the other hand, when the determination unit 240 determines that there is no available resource for executing the task (NO), the process proceeds to step S89.

In step S88, the execution unit 270 of the local edge computer EC executes the task obtained in step S83 or step S84. When the execution of the task is completed, the execution unit 270 transmits the execution result to the edge computer EC that is to execute a subsequent subtask. When there are no subsequent subtasks, the execution unit 270 transmits the execution result to the requesting EC.

In step S89, the determination unit 240 of the local edge computer EC stores the task obtained in step S83 in the queue stored in the storage unit 200. The task stored in the queue is obtained by the acquisition unit 220 when step S84 is executed again.

In step S90, the acquisition unit 220 of the local edge computer EC determines whether a task is stored in a queue stored in the storage unit 200. When the acquisition unit 220 determines that a task is stored in the queue (YES), the process returns to step S82. On the other hand, when the acquisition unit 220 determines that no task is stored in the queue (NO), the process ends.

According to the present embodiment, a task execution request in the grid computing system 1000 is issued based on priority-right control information stored in a definition list, without involvement of the server computer SV. In other words, the management server required in grid computing in the related art is no longer necessary. The task processing status or resource status of each edge computer EC can be shared by being distributed regularly. When the computing resources of the edge computer EC are sufficient, the edge computer EC can execute a task. As a result, the amount of communication for task execution is reduced.

The edge computer EC can only request another edge computer EC to execute a task when the computing resources of the local edge computer EC are insufficient. As a result, the amount of communication for a task with the management server is reduced.

A computing resource available for executing a task is defined for each edge computer EC in a definition list. Accordingly, a margin can be secured in the available resources of the edge computer EC. This increases the flexibility of the computing resources that each edge computer EC provides to grid computing.

The control of the edge computer EC having the priority right is performed based on the priority-right control information in the definition list. When priority-right control is to be added to existing grid computing, it is sufficient to distribute a definition list including priority-right control information. Accordingly, the control of the priority right can be performed with a high degree of flexibility.

### Modification

The grid computing system 1000 according to the above-described embodiment can be applied to grid computing for confidential data. The “confidential data” refers to data that is protected as personal information of an individual or as trade secrets of a company. Grid computing for confidential data is an example of a method in which data to be processed that is included in a task execution request is protected while being processed by grid computing.

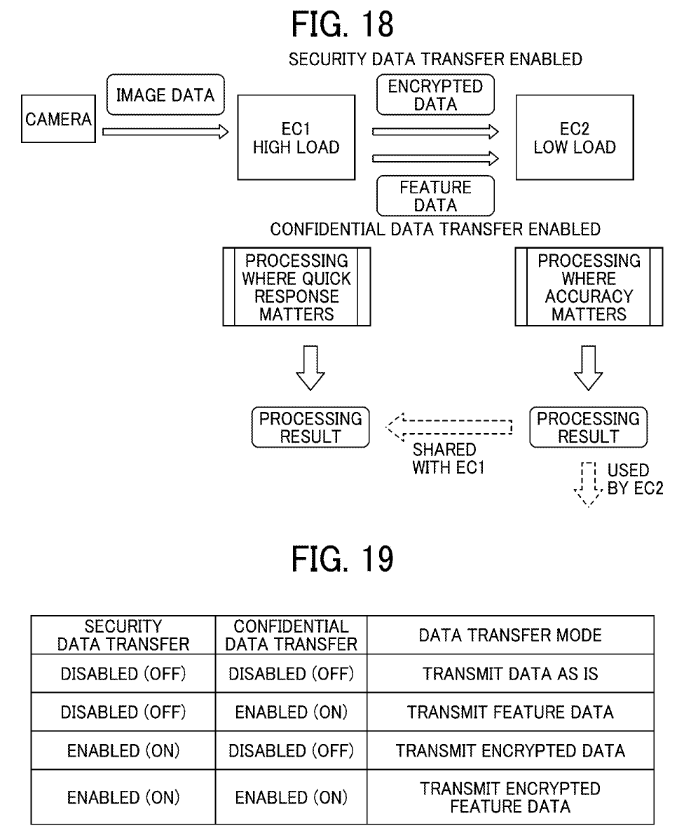

FIG. 18 is a diagram illustrating an example of grid computing for confidential data. For example, AI processing using camera images includes processing where quick response matters and processing where accuracy matters. Examples of processing where quick response matters include object recognition, segmentation, and security monitoring. Examples of processing where accuracy matters include image classification, image understanding, prediction, summarization, and visualization. Such AI processing can be efficiently performed by the grid computing system 1000.

AI processing for which quick response matters more than accuracy may be performed by the edge computer EC (in the example in FIG. 18, the edge computer EC1) that receives camera images even when the edge computer EC is under a high load. On the other hand, AI processing for which accuracy matters more than quick response can be processed by the edge computer EC with a low load (in the example in FIG. 18, the edge computer EC2) among the multiple edge computers EC participating in grid computing. In the task analysis of the embodiment, an edge computer EC with a low load can be identified, and a subtask including AI processing where accuracy matters can be requested to the edge computer EC with a low load.

In grid computing for confidential data, for example, when handling confidential data such as personal information or corporate information, data is protected by concealing raw data to be processed and then transmitting the raw data during communication between edge computers EC. In the following description, the raw data to be processed may be referred to simply as “target data.” The concealment may include encryption or feature extraction.

A data concealment method can be set for each edge computer EC. Accordingly, the data concealment method is changed according to the edge computer EC that is the transmission destination of a task execution request. The data concealment method may be defined in the definition list. The final processing result may be returned to the requesting EC (in the example in FIG. 18, the edge computer EC1) or used by the requested EC (in FIG. 18, the edge computer EC2).

FIG. 19 is a diagram illustrating an example of attribute information related to data concealment. As illustrated in FIG. 19, the attribute information related to data concealment includes security data transfer and confidential data transfer. The security data transfer and the confidential data transfer can be configured for each edge computer EC participating in grid computing. Further, each of the security data transfer and the confidential data transfer can be set to either enabled (ON) or disabled (OFF).

When both the security data transfer and the confidential data transfer are disabled, the requesting EC transmits data as is (without concealment) to the requested EC. When the security data transfer is enabled and the confidential data transfer is disabled, the requesting EC transmits data to the requested EC after encrypting the data. When the security data transfer is disabled and the confidential data transfer is enabled, the requesting EC transmits data obtained by performing feature extraction to the requested EC. When both the security data transfer and the confidential data transfer are enabled, the requesting EC transmits feature data obtained by performing feature extraction to the requested EC after encrypting the feature data.

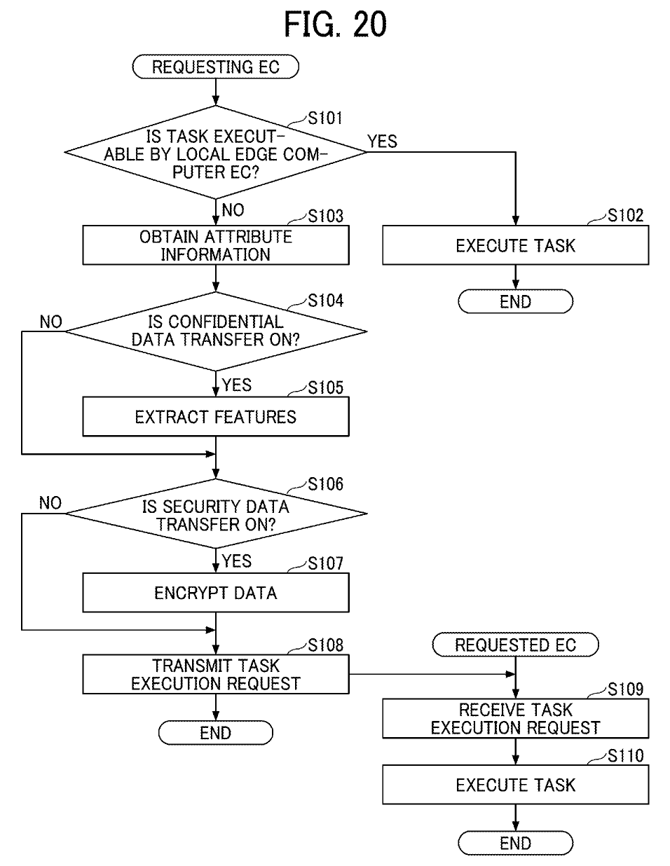

FIG. 20 is a flowchart of a process performed in grid computing for confidential data.

In step S101, the requesting EC determines whether a task is executable by the local edge computer EC. When determining that the task is executable by the local edge computer EC (YES), the requesting EC proceeds to step S102. In step S102, the requesting EC executes the task. On the other hand, when determining that the task is not executable by the local edge computer EC (NO), the requesting EC proceeds to step S103. In step S103, the requesting EC reads a definition list from the storage unit 200. The requesting EC obtains attribute information related to data concealment from the definition list.

In step S104, the requesting EC determines whether the confidential data transfer is enabled (ON). When the confidential data transfer is enabled (ON) (YES), the requesting EC proceeds to step S105. In step S105, the requesting EC extracts features from the target data of the task. The requesting EC generates feature data that indicates the extracted features. On the other hand, when the confidential data transfer is disabled (OFF) (NO), the requesting EC skips step S105 and proceeds to step S106.

In step S106, the requesting EC determines whether the security data transfer is enabled (ON). When the security data transfer is enabled (ON) (YES), the requesting EC proceeds to step S107. In step S107, the requesting EC encrypts the target data of the task. When feature data is generated in step S105, the requesting EC encrypts the feature data. The requesting EC obtains encrypted data resulting from encryption. On the other hand, when the security data transfer is disabled (OFF) (NO), the requesting EC skips step S107 and proceeds to step S108.

In step S108, the requesting EC transmits a task execution request to the requested EC. When both the confidential data transfer and the security data transfer are disabled, the task execution request includes the target data itself. When only the confidential data transfer is enabled, the task execution request includes the feature data. When only the security data transfer is enabled, the task execution request includes the encrypted data obtained by encrypting the target data. When both the confidential data transfer and the security data transfer are enabled, the task execution request includes encrypted data obtained by encrypting the feature data.

In step S109, the requested EC receives the task execution request from the requesting EC. In step S110, the requested EC executes the task in response to the task execution request. When the task execution request includes target data or feature data, the requested EC executes the task using the target data or feature data. When the task execution request includes encrypted data, the requested EC decrypts the encrypted data and executes the task using target data or feature data obtained from the decryption.

The flowchart illustrated in FIG. 20 simplifies some of the processing. The flowchart illustrated in FIG. 20 can be modified based on the steps of the flowchart illustrated in FIGS. 13 to 17.

### Other modifications

In the above-described embodiment, whether to perform distributed processing of a task is configurable. When the same task is to be executed by each edge computer EC, the task may be processed in a distributed manner.

When there are multiple edge computers EC that can execute the same processing, a route that selects the edge computer EC having the smallest load may be generated. In this case, the route may be generated so that the processing is completed only by edge computers EC having the same attribute information. This setting may be changed according to the processing content when processing is started initially. This setting may be configured automatically, or may be configured by specification.

According to a first aspect of the present embodiment, a program causes the edge computer EC1 to function as the acquisition unit 220 that acquires a first task, the planning unit 230 that generates an execution plan for the first task, the determination unit 240 that determines whether the edge computer EC1 holds the priority right, and, when it is determined that the edge computer EC1 holds the priority right, the transmission unit 250 that transmits a task execution request for the first task to another edge computer EC2 based on the execution plan.

According to a second aspect of the present embodiment, a program causes the edge computer EC2 to function as the determination unit that determines whether the edge computer EC2 holds the priority right, the reception unit 260 that, when it is determined that the edge computer EC2 does not hold the priority right, receives a task execution request for a second task from another edge computer EC1, and the execution unit 270 that executes the second task.

According to a third aspect of the present embodiment, a program causes the edge computer EC1 to function as the acquisition unit 220 that acquires a first task, the planning unit 230 that generates an execution plan for the first task, the determination unit 240 that determines whether the edge computer EC1 holds the priority right, the transmission unit 250 that, when it is determined that the edge computer EC1 holds the priority right, transmits, based on the execution plan, a task execution request for the first task to another edge computer EC2, the reception unit 260 that, when it is determined that the edge computer EC1 does not hold the priority right, receives from another edge computer EC2 a task execution request for a second task, and the execution unit 270 that executes the second task.

According to one aspect of the present embodiment, since, when an edge computer holds the priority right, the edge computer transmits a task execution request to another edge computer, it is possible to request execution of a task to an edge computer having available computing resources without providing, for example, a management server. Accordingly, according to the present embodiment, computing resources can be effectively utilized.

In the related art, there remains room for effectively utilizing available computing resources at each edge computer.

Each of the above-described functions may be implemented by one or more pieces of processing circuitry. The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or digital versatile disc (DVD), and/or the memory of an FPGA or ASIC.

Although embodiments of the present disclosure have been described above in detail, the embodiments disclosed herein are illustrative in all respects and are not limiting. The embodiments can be modified and improved in various forms without departing from the scope and spirit of the appended claims. Matters described in the above plural embodiments can be applied to other configurations insofar as they do not conflict with each other, and may be combined with each other insofar as they do not conflict with each other.

Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A non-transitory computer-readable recording medium storing a plurality of instructions which, when executed by one or more processors of an information processing apparatus, cause the one or more processors to perform a method, the method comprising:
obtaining a task;
generating an execution plan for the task;
determining whether the information processing apparatus holds a priority right to request another information processing apparatus to execute the task; and
when the information processing apparatus is determined to hold the priority right, transmitting a request to execute the task to said another information processing apparatus, based on the execution plan.

2. A non-transitory computer-readable recording medium storing instructions which, when executed by one or more processors of an information processing apparatus, cause the one or more processors to perform a method, the method comprising:
determining whether the information processing apparatus holds a priority right to request another information processing apparatus to execute a task;
when the information processing apparatus is determined not to hold the priority right, receiving, from said another information processing apparatus, a request to execute the task; and
executing the task.

3. The non-transitory computer-readable recording medium according to claim 1, wherein the method further comprises, when the information processing apparatus is determined not to hold the priority right, receiving, from said another information processing apparatus, a request to execute another task; and
executing said another task.

4. The non-transitory computer-readable recording medium according to claim 1, wherein the method further comprises switching the information processing apparatus that holds the priority right based on at least one of:
a priority order assigned to each of a plurality of information processing apparatuses including the information processing apparatus and said another information processing apparatus;
a holding time of the priority right at the information processing apparatus;
a number of task requests made by the information processing apparatus; and
an idle time of the information processing apparatus.

5. The non-transitory computer-readable recording medium according to claim 4,
wherein the switching including switching the information processing apparatus that holds the priority right when either one of a threshold for the holding time of the priority right and a threshold for the number of task requests is exceeded, and
wherein the threshold is different among the plurality of information processing apparatuses.

6. The non-transitory computer-readable recording medium according to claim 1,
wherein the method further includes managing available resources for executing the task, and
wherein the determining includes determining whether the information processing apparatus holds the priority right when the information processing apparatus does not have available resources for executing the task.

7. The non-transitory computer-readable recording medium according to claim 2,
wherein the method further comprises managing available resources for executing the task, and
wherein the receiving includes the receiving the request to execute the task when the information processing apparatus has available resources for executing the task.

8. The non-transitory computer-readable recording medium according to claim 1, wherein the execution plan specifies an execution order of subtasks obtained by splitting the task.

9. The non-transitory computer-readable recording medium according to claim 8, wherein the method further comprises generating the execution plan in which said another information processing apparatus to which execution of one or more of the subtasks is requested is assigned based on available resources of said another information processing apparatus.

10. The non-transitory computer-readable recording medium according to claim 1, wherein the method further comprises transmitting a task execution request in which target data of the task is concealed by a concealment method corresponding to said another information processing apparatus that is a transmission destination of the task execution request.

11. An information processing apparatus, comprising circuitry configured to:
obtain a task;
generate an execution plan for the task;
determine whether the information processing apparatus holds a priority right to request another information processing apparatus to execute the task; and
when the information processing apparatus is determined to hold the priority right, transmit a request to execute the task to said another information processing apparatus, based on the execution plan.

12. The information processing apparatus according to claim 11, wherein, when the information processing apparatus is determined not to hold the priority right, the circuitry is further configured to:
receive another request to execute another task from another information processing apparatus; and
execute said another task.
